(19) United States
(12) Patent Application Publication
(10) Pub. No.: US 2024/0327711 A1
(43) Pub. Date: Oct. 3, 2024

(54) Multi-component phase change material flame retardant, method for preparing, and application thereof

(71) Applicant: China Academy of Safety Science and Technology, Beijing (CN)

(72) Inventors: Congling SHI, Beijing (CN); Xiaodong QIAN, Beijing (CN); Li HE, Beijing (CN); Honglei CHE, Beijing (CN); Mei WAN, Beijing (CN); Jingyun JING, Beijing (CN); Guolin LIU, Beijing (CN); Dan WANG, Beijing (CN); Fei REN, Beijing (CN)

(73) Assignee: China Academy of Safety Science and Technology, Beijing (CN)

(21) Appl. No.: 18/624,049

(22) Filed: Apr. 1, 2024

(30) Foreign Application Priority Data
Apr. 3, 2023 (CN) 202310343935.9

(51) Int. Cl. C09K 21/02; C09K 21/14

(52) U.S. Cl. CPC C09K 21/02; C09K 21/14

(57) ABSTRACT

The present disclosure relates to a flame retardant composed of multi-component phase change material particles. These particles consist of paraffin wax, nano-flame retardant, and conventional flame retardant. The phase change material is modified with nano-flame retardant and physically coated with conventional flame retardant. The multi-component phase change material flame retardant is formed by creating a two-layer nucleus-shell structure. The nucleus core is made up of the conventional flame retardant, while the shell layer is composed of the nano-flame retardant doped phase change material. The multi-component flame retardant material combines the performance advantages of phase change material, nano flame retardant, and conventional flame retardant. The combination of nano flame retardant and phase change material weakens the disadvantages of phase change material and allows for the full utilization of the energy storage capabilities of the phase change material.

### CROSS-REFERENCE TO RELATED APPLICATIONS

This application claims priority to Chinese Patent Application No. 202310343935.9 filed on Apr. 3, 2023, the disclosure of which is hereby incorporated by reference in their entirety.

### BACKGROUND

Phase change material is defined as a substance that changes state with temperature, meanwhile provides latent heat. The process of transformation of physical properties is known as phase change processes, in which the phase change material absorbs or releases a large amount of latent heat. Phase change materials are applied in the field of flame retardancy due to the heat-absorbing properties of changing from solid to liquid state. The material structure and recyclable utility of phase change materials response to green, environmental protection, and sustainable development initiatives, thereby presenting a broad application prospect.

Phosphorus-based flame retardants, such as ammonium polyphosphate, exhibit highly efficient flame-retardant properties. They effectively reduce heat and smoke release from composite materials, and significantly enhance the robustness of the protective carbon layer while increasing the amount of carbon residue. Despite the exceptional flame retardancy, phosphorus flame retardants have defects. To achieve efficient flame retardancy, large quantities of phosphorus flame retardants are typically required. However, the addition of inorganic flame retardants can significantly diminish the mechanical properties of the composite material. Thus, the challenge is how to avoid or reduce the deterioration of mechanical properties while ensuring effective flame retardancy.

The Chinese invention patent publication document CN111154229A discloses a flame-retardant phase change material film, which applies the phase change material to flame-retardant. However, its component configuration and structural design are deemed incomplete. On the other hand, the Chinese invention patent publication document CN104592947A discloses a flame-retardant organic phase change material and its method, involving the mixing of carbon nanotubes, organic phase change material and organic solvent. Nevertheless, it lacks refinement in terms of a specified combination method.

### SUMMARY

The present disclosure relates to the technical field of flame retardants, particularly relates to a multi-component phase change material flame retardant, method for preparing the same, and application thereof.

In response to the problems existing in the prior art, the present disclosure provides a multi-component phase change material flame retardant, preparation method, and application thereof.

The present disclosure is realized by the following technical solutions:

The present disclosure provides a multi-component phase change material flame retardant, composed of phase change material, nano flame retardant and conventional flame retardant.

Wherein the core structure is conventional flame retardant and the shell structure is nano flame retardant doped phase change material.

Further, said conventional flame retardant is one or more of aluminum hydroxide (ATH), ammonium polyphosphate (APP), dicyandiamide (DCD), expanded graphite (EG), melamine cyanurate (MCA), magnesium hydroxide (MDH), melamine (MEL), melamine polyphosphate (MPP), pentaerythritol (PER).

Further, said nano flame retardant is one or more of MXene, graphene sheets (GNS), graphene oxide (GO), carbon nanotubes (CNT).

Further, said phase change material is paraffin wax.

Further, the mass ratio of said paraffin wax, nano flame retardant and conventional flame retardant is (1-5):(1-3):(1-20).

Further, the preparation method of said multi-component phase change material flame retardant specifically includes the following steps:

(1) Placing the phase change material in a vessel (three-mouth flask) with a stirring device and a constant temperature water bath until it becomes completely liquid. During the stirring process, adding the nano-flame retardant slowly into the flask until it was completely mixed homogeneously.

(2) Placing the conventional flame retardant in a beaker at room temperature, adding the product of step (1) slowly for several times, stirring the mixed solution continuously and powerfully, to make the phase change material fully encapsulates the conventional flame retardant particles.

Further, said step (1) includes a constant temperature water bath of 70-150° C. for 30-90 min for this phase change material paraffin wax.

Further, said step (1) comprises cooling down the phase change material paraffin wax to 50-90° C. after melting.

Further, said step (1) comprises stirring for 20-60 min after mixing with the nano flame retardant.

Further, said step (2) comprises coating conditions at room temperature of 10-25° C., continuous strong stirring before complete solidification of the phase change material, and a rotational speed of 600-1200 r/min for strong stirring.

Said “slowly for several times” in step (2) is specified as first adding 1-88% (preferably 2-80%, further preferably 15-80%) of the mixing product to the vessel within 5-30 min, then adding the remaining mixing product to the vessel in 2-12 times, and maintaining the time of each addition within 1-10 min.

Further, said multi-component phase change material flame retardant is applied in polymer flame retardancy.

Further, said polymer is one or more of epoxy resin, polyester or polyolefin material, and said multi-component phase change material flame retardant is added in an amount of 1-20 wt. %.

Further, said MXene is prepared as follows:

(1) Placing concentrated hydrochloric acid and ultrapure water in a vessel (such as PTFE plastic vessel), configuring 8-10 mol/L hydrochloric acid solution, and placing the vessel in an oil bath.

(2) Adding LiF and Ti₃AlC₂ slowly for several times into the hydrochloric acid solution configured in step (1), keeping the reaction at 30-40° C. for 24-72 h, wherein the mass ratio of LiF and Ti₃AlC₂ is (1-2):(1-2).

(3) Centrifuging the product obtained in step (2) at the end of the reaction, washing the solids several times with deionized water until the pH of the supernatant is 6.5-7.5.

(4) Ultrasonically dispersing the precipitate obtained from step (3) in deionized water for 1.5-2.5 h to obtain a suspension solution of MXene.

(5) Centrifuging the MXene suspension solution from step (4) in a centrifuge (3000-3800 r/min) for 20-30 min, taking the supernatant and setting aside.

(6) Placing the product obtained in step (5) in a freeze dryer for freeze drying for 40-55 h, finally obtaining the MXene product.

Further, said graphene oxide (GO) is prepared as follows:

(1) Adding concentrated sulfuric acid into a vessel (such as a beaker) and placing it in an ice water bath until the temperature is −1 to 2° C.

(2) During continuous stirring, adding graphite powder and sodium nitrate slowly into the liquid in step (1) for several times, wherein the ratio of graphite powder, sodium nitrate and concentrated sulfuric acid is (1.2-1.8 g):(0.5-0.9 g):(30-40 mL), maintaining the temperature of the system at no more than 3-6° C. during this process.

(3) After sufficient stirring of the mixture of step (2), adding potassium permanganate slowly into the mixture obtained in step (2) for several times, wherein the mass ratio of the addition amount of potassium permanganate and the graphite powder is (2.5-3.5):1, and this process ensured that the temperature of the system was 0-5° C.

(4) Transferring the mixed solution obtained in step (3) to a water bath, warming up to 30-38° C., and stirring continuously for 0.3-0.8 h.

(5) Adding deionized water (the addition amount is 1.5-2.5 times the volume of concentrated sulfuric acid) slowly into the mixed solution obtained in phase step (4), adjusting the temperature to 90-105° C., keeping reacting for 12-18 min.

(6) Cooling for 8-15 min in the water bath at the end of the reaction, sequentially adding 28-35% hydrogen peroxide solution and deionized water into the mixed solution, wherein the volume ratio of hydrogen peroxide solution, deionized water and concentrated sulfuric acid is (18-22):(410-430):(32-38).

(7) Cooling down the mixture obtained in step (6) to room temperature, centrifugally washing several times until SO₄²⁻ is cleaned, vacuum drying at 55-65° C. to obtain the product graphene oxide (GO).

Preferably, said polymer is rigid polyurethane foam (RPUF).

### BENEFICIAL EFFECTS OF THE PRESENT DISCLOSURE

The present disclosure coats a phase change material mixed with a nano flame retardant on the surface of a phosphorus-based flame retardant. A flame retardant phase change material in a surface-coated form is prepared by physically coating a conventional flame retardant with the phase change material modified by a nano flame retardant, and forming a double-layer core-shell structure. Consequently, the performance advantages of phase change materials (paraffin wax), nano flame retardants and conventional flame retardants are combined. By setting up each core-shell ministries specifically and coordinating them closely through the preparation method, the performance advantages of each part are not individually apparent, but to achieve the high efficiency of the superposition, which means the effect is superior to the effect of each individual. Multi-flame-retardant elements work synergistically to give full play to the gas-phase and condensed-phase flame retardant mechanism, and to demonstrate the excellent thermal stability and flame-retardant properties.

The combination of nano-flame retardants and phase change materials weakens the disadvantages of phase change materials, giving full play to the role of energy storage of phase change materials, absorbing heat energy through the phase change in the early stage of fire, reducing the temperature of combustion products, and effectively inhibiting the combustion and development of flames. The synergistic effect of conventional flame retardants on polymers shows excellent thermal stability and flame-retardant properties, providing new ideas for the application of flame retardant.

The present disclosure makes the obtained coating structure optimize the coordinated advantages of the above multi-components while offsetting their respective drawbacks through the specific limitation of the ratio of the content of each component, the specific limitation of the coating structure, and the optimization and setting of each parameter in the process of the preparation method. The optimal coordination mode is achieved through offsetting respective drawbacks of each component.

The present disclosure makes the obtained coating structure optimize the coordinated advantages of the above multi-components while offsetting their respective drawbacks through the specific limitation of the ratio of the content of each component, the specific limitation of the coating structure, and the optimization and setting of each parameter in the process of the preparation method. The optimal coordination mode is achieved through offsetting respective drawbacks of each component.

### BRIEF DESCRIPTION OF DRAWINGS

FIG. 1 shows a schematic structure of the multi-component phase change material flame retardant of the present disclosure.

Wherein 1 represents the phase change material part, 2 represents the conventional flame retardant part, and 3 represents the nano flame retardant part.

### DETAILED DESCRIPTION

In order to make the purpose, technical solutions and advantages of the embodiments of the present disclosure clearer, the technical solutions in the embodiments of the present disclosure are described clearly and completely in the following, and it is obvious that the described embodiments are a part of the embodiments of the present disclosure and not all of the embodiments. Based on the embodiments in the present disclosure, all other embodiments obtained by those skilled in the art without making creative labor are within the scope of protection of the present disclosure.

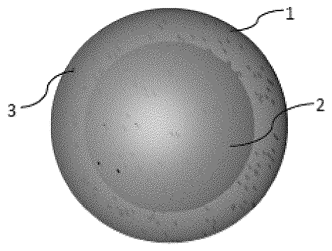

An example is carried out as shown in FIG. 1, wherein the nano flame retardant part and the phase change material part are located in the shell part, and the conventional flame retardant is the core part. FIG. 1 shows a schematic diagram in semi-perspective view.

### Embodiment 1

The present embodiment provides a multi-component core-shell structural flame retardant, which is ammonium polyphosphate (APP) coated with paraffin wax (PW) and MXene.

This embodiment also provides a method of preparing the above multi-component core-shell structure flame retardant in the following steps:

(1) Placing concentrated hydrochloric acid and ultrapure water in a PTFE plastic vessel to configure a 9 mol/L hydrochloric acid solution, and placing the vessel in an oil bath.

(2) Adding 1 g of LiF and 1 g of Ti₃AlC₂ slowly for several times into the hydrochloric acid solution configured in step (1), keeping the reaction at 35° C. for 48 h.

(3) At the end of the reaction, centrifuging the product of step (2), washing with deionized water several times until the supernatant PH≈7.

(4) Ultrasonically dispersing the precipitate obtained from step (3) in deionized water for 2 h to obtain MXene suspension solution.

(5) Centrifuging The suspension from step (4) in a centrifuge (3500 r/min) for 25 min, taking the supernatant and setting aside.

(6) Placing the product of step (5) in a freeze dryer for 48 h to obtain the MXene product.

(7) Placing the paraffin wax in a three-necked flask with stirring device, providing a constant temperature water bath at 90° C. for 30 min until it becomes completely liquid, cooling down to 60° C.

(8) Adding MXene flame retardant slowly into step (7), during the stirring process, stirring continuously for 30 min until completely mixed homogeneously to obtain flame retardant paraffin wax.

(9) Placing the conventional flame retardant APP in an empty beaker at room temperature, adding the product of step (8) slowly for several times, stirring the mixed solution strongly and continuously, making the flame-retardant paraffin waxes sufficiently wrap the APP particles, to obtain the final product after cooling, which is named as: APP@PW-MXene.

### Embodiment 2

This embodiment provides a multi-component phase change material flame retardant which is APP coated with PW and graphene oxide (GO).

The present embodiment also provides a method of preparing the above multi-component phase change material flame retardant in the following steps:

(1) Adding 35 mL of concentrated sulfuric acid into 500 ml beaker with ice water bath until the temperature is approximately 0° C.

(2) Adding 1.5 g of graphite powder and 0.75 g of sodium nitrate slowly into step (1) for several times during continuous stirring, maintaining the temperature of the system at no more than 4° C. during this process.

(3) Adding 4.5 g potassium permanganate slowly into the product of step (2) after sufficient stirring for several times, maintaining the temperature of the system in 0-5° C. during the process.

(4) Transferring the mixed solution in step (3) to a water bath, warming up to 35° C. and stirring continuously for half an hour.

(5) Adding the mixed solution in step (4) slowly into 69 mL of deionized water, adjusting the temperature to 98° C., reacting for 15 min.

(6) Cooling in the water bath for 10 min at the end of the reaction, adding 20 mL of 30% hydrogen peroxide solution and 420 mL of deionized water into the mixed solution sequentially.

(7) Cooling to room temperature, centrifuging and washing several times until SO₄²⁻ is cleaned, drying in vacuum at 60° C. to obtain the product GO.

(8) Placing the paraffin wax in a three-necked flask with stirring device, providing a constant temperature water bath at 90° C. for 30 min until the paraffin wax become completely liquid, cooling down to 60° C.

(9) Adding the GO flame retardant slowly into step (8) during the stirring process, stirring continuously for 30 min until completely mixed homogeneously to obtain flame-retardant paraffin wax.

(10) Placing the conventional flame retardant APP in an empty beaker at room temperature, adding the product of step (9) slowly for several times, stirring the mixed solution strongly and continuously, making the flame-retardant paraffin waxes sufficiently wrap the APP particles, to obtain the final product after cooling, which was named as: APP@PW-GO.

### Application Example 1

This application example provides an application of a multi-component phase change material flame-retardant rigid polyurethane foam (RPUF) in the form of an RPUF/10% APP@PW-MXene composite.

This application example also provides the preparation method of the above RPUF in the following steps:

(1) Weighing 50 g of polyether polyol 950 and 50 g of isocyanate 950 at room temperature and setting aside.

(2) Placing APP@PW-MXene (10 g) in Embodiment 1 into the polyether polyol 950 in step (1), ultrasonically stirring for 30 min until mixed homogeneously.

(3) Mixing the mixed product in step (2) with the isocyanate 950 in step (1) in a mold with continuous stirring, foaming for the final product RPUF/10% APP@PW-MXene composite after 30 s.

### Application Example 2

This application example provides an application of a multi-component phase change material flame-retardant rigid polyurethane foam (RPUF) in the form of an RPUF/10% APP@PW-GO composite.

This application example also provides the preparation method of the above RPUF in the following steps:

(1) Weighing 50 g of polyether polyol 950 and 50 g of isocyanate 950 at room temperature and setting aside.

(2) Placing APP@PW-GO (10 g) in Embodiment 2 into the polyether polyol 950 in step (1), ultrasonically stirring for 30 min until mixed homogeneously.

(3) Mixing the mixed product in step (2) with the isocyanate 950 in step (1) in a mold with continuous stirring, foaming for the final product RPUF/10% APP@PW-GO composite after 30 s.

### Comparison 1

This comparison provides an RPUF which is a pure sample of RPUF without any flame retardant addition.

This comparison also provides a preparation method of the above pure sample of RPUF in the following steps:

(1) Weighing 50 g of polyether polyol 950 and 50 g of isocyanate 950 and setting aside.

(2) Placing the solution in step (1) in a mold to mix, stirring continuously, foaming after about 30 s to obtain the pure sample of RPUF.

### Comparison 2

This comparison provides an RPUF/15% APP@PW-MXene composite material, wherein said RPUF/15% APP@PW-MXene is prepared in substantially the same way as in Application Example 1, with the difference being that the addition amount of 10 g APP@PW-MXene is replaced with 15 g.

### Comparison 3

This comparison provides an RPUF/20% APP@PW-MXene composite material, wherein said RPUF/20% APP@PW-MXene is prepared in substantially the same way as Application Example 1, with the difference that the addition amount of 10 g APP@PW-MXene is replaced with 20 g.

### Comparison 4

This comparison provides an RPUF/15% APP@PW-GO composite material, wherein said RPUF/15% APP@PW-GO is prepared in substantially the same way as in Application Example 2, with the difference that the addition amount of 10 g APP@PW-GO is replaced with 15 g.

### Comparison 5

This comparison provides an RPUF/20% APP@PW-GO composite material, wherein said RPUF/20% APP@PW-GO is prepared in substantially the same way as in Application Example 2, with the difference that the addition amount of 10 g APP@PW-GO is replaced with 20 g.

The oxygen index test results for the RPUF composites obtained from Application Examples 1 to 2 and Comparisons 1 to 5 are represented in Table 1.

TABLE 1

| | Sample | LOI/% |
|---|---|---|
| Comparison 1 | Pure sample of RPUF | 19.0 |
| Application Example 1 | RPUF/10% APP@PW-MXene | 25.2 |
| Comparison 2 | RPUF/15% APP@PW-MXene | 27.0 |
| Comparison 3 | RPUF/20% APP@PW-MXene | 29.5 |
| Application Example 2 | RPUF/10% APP@PW-GO | 25.4 |
| Comparison 4 | RPUF/15% APP@PW-GO | 27.3 |
| Comparison 5 | RPUF/20% APP@PW-GO | 29.9 |

Table 1 shows that compared to the pure sample of RPUF without any addition of flame retardant, the specific addition of the multicomponent phase change material flame retardant, specifically set up by the present disclosure, notably enhances its Limiting Oxygen Index (LOI). Consequently, the flame retardant effect is significantly improved. The comparisons established within the present disclosure are not conventional in nature, but rather specifically in comparison with the embodiments of the present disclosure. Additionally, alternative embodiment within the scope of the present disclosure also shows that within specified range of the addition, an increase in the addition amount leads to a corresponding enhancement in the LOI to a certain extent.

Finally, it should be noted that the aforementioned embodiments are only used to illustrate the technical solution of the present disclosure, not to constrain it. Although the present disclosure has been described in detail with reference to the aforementioned embodiments, it is imperative for those skilled in the art to recognize the potential for modifications to the recorded technical solution or the substitution of certain technical features with equivalents. Such modifications or substitutions do not deviate from the essence of the corresponding technical solutions within the embodiments of the present disclosure, nor do they alter the scope of said embodiments.

What is claimed is:

1. A multi-component phase change material flame retardant, wherein said multi-component phase change material flame retardant has a double-layer core-shell structure composed of a core and a shell layer, wherein the core is a conventional flame retardant and the shell layer is a nano-flame retardant doped phase change material, and said phase change material modified by said nano-flame retardant is physically coated on the outside of the conventional flame retardant to form a double-layer core-shell structure;
the mass ratio of said phase change material, nano flame retardant and conventional flame retardant in the double-layer core-shell structure is (1-5):(1-3):(1-20);
said conventional flame retardant is one or more of aluminum hydroxide (ATH), ammonium polyphosphate (APP), dicyandiamide (DCD), expanded graphite (EG), melamine cyanurate (MCA), magnesium hydroxide (MDH), melamine (MEL), melamine polyphosphate (MPP) or pentaerythritol (PER);
said nano flame retardant is one or more of MXene, graphene sheets (GNS), graphene oxide (GO) or carbon nanotubes (CNT).

2. The multi-component phase change material flame retardant according to claim 1, wherein said phase change material is paraffin wax.

3. A method for preparing a multi-component phase change material flame retardant, wherein said multi-component phase change material flame retardant has a double-layer core-shell structure composed of a core and a shell layer, wherein the core is a conventional flame retardant and the shell layer is a nano-flame retardant doped phase change material, and said phase change material modified by said nano-flame retardant is physically coated on the outside of the conventional flame retardant to form a double-layer core-shell structure;
the mass ratio of said phase change material, nano flame retardant and conventional flame retardant in the double-layer core-shell structure is (1-5):(1-3):(1-20);
said conventional flame retardant is one or more of aluminum hydroxide (ATH), ammonium polyphosphate (APP), dicyandiamide (DCD), expanded graphite (EG), melamine cyanurate (MCA), magnesium hydroxide (MDH), melamine (MEL), melamine polyphosphate (MPP) or pentaerythritol (PER);
said nano flame retardant is one or more of MXene, graphene sheets (GNS), graphene oxide (GO) or carbon nanotubes (CNT); and said method of preparation comprising the following steps:
(1) placing the phase change material in a vessel with a stirring device, carrying out a constant temperature water bath at 70-150° C. for 30-90 min until the phase change material completely becomes liquid, and reducing the temperature to 50-90° C., slowly adding the nano-flame retardant into the vessel in the process of continuing the stirring process, continuing stirring until it is completely mixed uniformly;
(2) placing the conventional flame retardant particles in a vessel with a stirring device at a temperature of 10-30° C., slowly for several times adding the mixed product obtained in step (1) into the vessel, continuously and powerfully stirring the mixed solution to fully encapsulate the phase-change material on the outside of the conventional flame retardant particles.

4. The method for preparation according to claim 3, wherein said vessel in step (1) and step (2) is three-necked flask.

5. The method of preparation according to claim 3, wherein the total time of stirring in step (1) is 20-60 min.

6. The method of preparation according to claim 3, wherein the temperature conditions in step (2) are 10-25° C., and strong stirring is continuously carried out before the phase change material is completely solidified, and said strong stirring is stirring at a speed of 600-1200 r/min.

7. The method of preparation according to claim 3, wherein said slowly for several times in step (2) is specified as first adding 1-88% of the mixing product into the vessel within 5-30 min, and then adding the remaining mixing product into the vessel in 2-12 times, with the time of each addition maintained within 1-10 min.

8. An application of a multi-component phase change material flame retardant, wherein said application is an application in polymer flame retardancy, said multi-component phase change material flame retardant has a double-layer core-shell structure composed of a core and a shell layer, wherein the core is a conventional flame retardant and the shell layer is a nano-flame retardant doped phase change material, and said phase change material modified by said nano-flame retardant is physically coated on the outside of the conventional flame retardant to form a double-layer core-shell structure;
the mass ratio of said phase change material, nano flame retardant and conventional flame retardant in the double-layer core-shell structure is (1-5):(1-3):(1-20);
said conventional flame retardant is one or more of aluminum hydroxide (ATH), ammonium polyphosphate (APP), dicyandiamide (DCD), expanded graphite (EG), melamine cyanurate (MCA), magnesium hydroxide (MDH), melamine (MEL), melamine polyphosphate (MPP) or pentaerythritol (PER);
said nano flame retardant is one or more of MXene, graphene sheets (GNS), graphene oxide (GO) or carbon nanotubes (CNT); or the multi-component phase change material flame retardant prepared by the following steps:
(1) placing the phase change material in a vessel with a stirring device, carrying out a constant temperature water bath at 70-150° C. for 30-90 min until the phase change material completely becomes liquid, and reducing the temperature to 50-90° C., slowly adding the nano-flame retardant into the vessel in the process of continuing the stirring process, continuing stirring until it is completely mixed uniformly;
(2) placing the conventional flame retardant particles in a vessel with a stirring device at a temperature of 10-30° C., slowly for several times adding the mixed product obtained in step (1) into the vessel, continuously and powerfully stirring the mixed solution to fully encapsulate the phase-change material on the outside of the conventional flame retardant particles.

9. The application according to claim 8, wherein said polymer is one or more of epoxy resin, polyester or polyolefin material, and the addition amount of said multi-component phase change material flame retardant applied in the polymer flame retardant is 1-20 wt. %.

10. The application according to claim 9, wherein said polymer is rigid polyurethane foam (RPUF).
